(19) United States
(12) Patent Application Publication
(10) Pub. No.: US 2017/0066095 A1
(43) Pub. Date: Mar. 9, 2017

(54) DUST COLLECTOR FOR ELECTRICAL DRILL

(71) Applicant: Chao-Yang Chen, New Taipei City (TW)

(72) Inventor: Chao-Yang Chen, New Taipei City (TW)

(21) Appl. No.: 14/848,356

(22) Filed: Sep. 9, 2015

(51) Int. Cl. B23Q 11/00

(52) U.S. Cl. CPC B23Q 11/0071

(57) ABSTRACT

a dust collector for electrical drill, comprising: a sleeve portion, a supporting portion, and a dust collecting portion; the sleeve portion disposed in front of the fixing part of the electrical drill; the supporting portion coupled with the sleeve portion, and surrounding and isolating a rotating part of the electrical drill; the dust collecting portion coupled with one end of the supporting portion and covered the drill bit; the dust collecting portion including a telescoping sleeve body and a spring. Besides, the dust collector adds a stop device which comprises a ruler paralleled to the dust collection portion and a stopper disposed in the outside of the supporting portion, whereby collecting the dust when drilling operation and controlling precisely the drilling depth.

### FIELD OF THE INVENTION

The present invention relates to a dust collector arranged on the electrical drill and configured to collect the dust.

### BACKGROUND OF THE INVENTION

While using an electrical drill, a large amount of dust flying around fills the air, not only affecting the air quality and user's breathing but resulting in unclean and untidy environment.

In view of above question, the reference No: EP 1842612 A1 disclosed a dust collector without a spring, it is not easy to press against the wall, which will result in the dust leaking out of the dust collector. Besides, the dust collector is only sleeved with a supporting portion without fixed each other, which will be removable easily. Moreover, the supporting portion is a hard element that must be changed to other one to fit different diameter drill bits, which will increase the production costs.

Moreover, the reference No.: US 2013/0094915 A1 disclosed a bearing disposed in a sleeve portion to fit with a rotating portion of a drill, and fixed with the sleeve portion and a fixing portion of the drill, but what if the rotating portion is changed to other size, the bearing also must be changed to different one to fit with the rotating portion, which will also increase the production costs. Besides, when drilling operation, the user usually do not precisely control the drilling depth, resulting too shallow or too deep in drilling depth. Therefore, the objects of present invention in to solve the above mentioned problems.

### SUMMARY OF INVENTION

In order to achieve the above objects of the present invention, a dust collector for electrical drill, comprising a sleeve portion, a supporting portion, and a dust collecting portion; the sleeve portion, defining a hollow sleeve configured to retain a fixing part and a rotating part of the electrical drill, one end of which is coupled with the fixing part of the electrical drill and the other end is connected with the supporting portion; the sleeve portion surrounding, isolating, and keeping clear of the rotating part disposed in a front section of the fixing part; the supporting portion, defining an annular ring having a through hole disposed in a center thereof provided for a drill bit inserted therethrough, one end of which is coupled with sleeve port and the other end connected with the dust collecting portion; the dust collecting portion, including a telescoping sleeve body coupled to the supporting portion and a spring disposed inside the telescoping sleeve body; the telescoping sleeve body sequentially comprising a ring body, a dust collection section, a bellows section, a connecting ring; the ring body having an opening provided for the drill bit passing therethrough; the dust collection section connected to the corresponding end of the ring body, the bellows section connected to the other corresponding end of the dust collection section, the connecting ring connected to the other corresponding end of the bellows section, and the other end of the connecting ring connected to an outer periphery of the supporting portion; the spring, defining a compression spring and disposed around the outside periphery of the drill bit, one end of which is coupled with an inner wall of the ring body and the other end is positioned in a corresponding position of the supporting portion.

wherein the supporting portion comprises an inner ring body (20) axially corresponding and connected to the sleeve portion, an outer ring body axially corresponding and connected to the inner ring body, and the diameter of which being larger than the inner ring body; one end of the inner and outer ring body being integrally connected by a vertical block ring, which forms a dust collection chamber arranged therebetween; the dust collection chamber having a filter net and the block ring having a plurality of air outlets corresponding to the filter net; wherein the filter net of the dust collection chamber has two partition plates arranged at both sides for fixing the filter net.

Wherein the inner ring body includes a bottom ring disposed in one end thereof, at least two positioning blocks correspondingly arranged in an outer face thereof, and at least two inverted L-shaped protruding blocks correspondingly disposed and staggered with the positioning blocks for fixing the spring in the outer face of the bottom ring.

wherein the bottom ring further includes a flexible block plate to block the through hole, a perforation disposed in a center circle of the block plate to allow the drill bit passing therethrough, a plurality of slits evenly arranged around the perforation, and a plurality of locating holes configured to fix the positioning blocks and the protruding blocks.

wherein the connecting ring of the dust collecting portion is connected to an outer periphery of the outer ring body and has a convex ring disposed around an outer edge thereof; the outer ring body including a stop ring arranged around the outer periphery thereof to block the convex ring for a better sealing effect, at least two lugs arranged in corresponding positions, and at least two fasteners with hooks arranged at both sides of lugs and fastened to a top edge of the connecting ring and the outer ring body.

Wherein the sleeve portion comprises a thickened inner wall corresponding to the fixing part of the electrical drill for receiving the fixing part and an outer thread arranged in an outer periphery of one end thereof for screwing to the supporting portion which has an inner thread corresponding to the outer thread.

Wherein the supporting portion includes an annular convex strip disposed in an outer face between the supporting portion and the connecting ring, and an annular concave groove arranged in an inner wall of the connecting ring and corresponding to the convex strip.

A dust collector for electrical drill further comprising a stop device which comprises an ruler with scales paralleled to the dust collecting portion and being adjustable in length, a stopper disposed at the outer edge of the supporting portion, a fixing hole arranged in one end of the stopper and configured to move and fix the ruler, and a locating pillar disposed in the other end of the stopper and coupled to the supporting portion; the supporting portion having a locating recess disposed in the outer edge thereof provided for the locating pillar inserted therein.

wherein the locating recess has a positioning hole disposed in one side wall thereof, and the locating pillar has a spring block disposed in one side wall thereof for inserting into the positioning hole.

Compared with the prior art, the utility model has the beneficial effects are that:
1. The sleeve portion and the supporting portion are coupled together using thread connection, and the supporting portion and the dust collecting portion sleeved and fixed using the fastener, which can totally fix the dust collector in the drill.
2. The stop device can measure the drilling depth when drilling operation.
3. The hole of the supporting portion is disposed in the flexible block plate which has the perforation and the slits, whereby fitting large drilling bit and rotating part, and avoiding the dust leaking out of the dust collector.
4. The inner wall of the sleeve portion increase the thickness, which can fit the fixing part of the electrical drill and avoid falling off therefrom.
5. The connecting ring is sleeved with the outer periphery of the outer ring body, the connecting having a convex ring and the outer ring body having a stop ring, which can achieve better sealing effect.
6. The dust collection chamber having a filter net to avoid air contamination.

### BRIEF DESCRIPTION OF THE DRAWINGS

FIG. 1 is a structure schematic view of the first embodiment of the present invention;

FIG. 2 is an exploded view of the first embodiment of the present invention;

FIG. 3 is an exploded view from another angle of the first embodiment of the present invention;

FIG. 4 is a structure sectional view of the first embodiment of the present invention;

FIG. 5 to FIG. 7 are schematic views showing drilling operation of the first embodiment of the present invention;

FIG. 8 is a structure schematic view of the second embodiment of the present invention;

FIG. 9 is an exploded view of the second embodiment of the present invention;

FIG. 10 is a structure sectional view of the second embodiment of the present invention;

FIG. 11 to FIG. 13 are schematic views showing drilling operation of the second embodiment of the present invention.

### DETAILED DESCRIPTION OF THE PREFERRED EMBODIMENTS

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

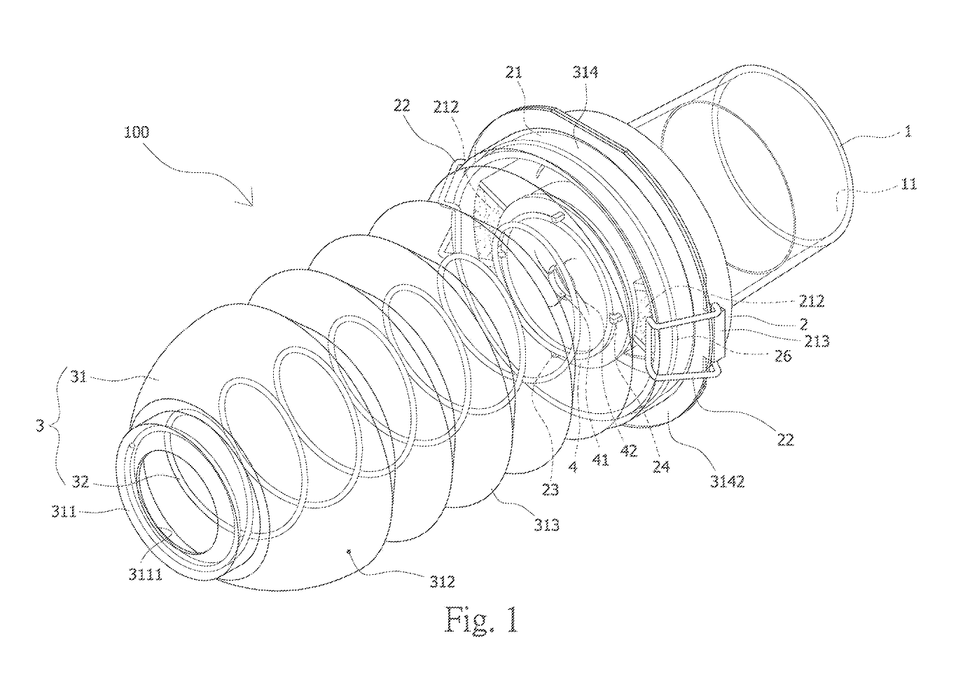

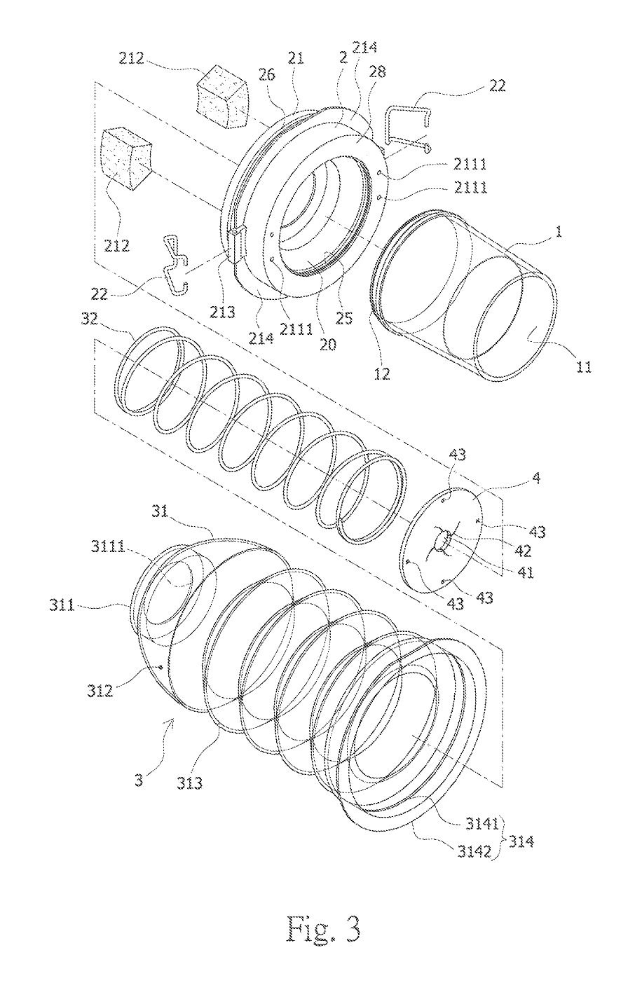

FIG. 1 to FIG. 4 disclose a structure of the first embodiment, which is a dust collector (100) for electrical drill (200), comprising: a sleeve portion (1), a supporting portion (2), and a dust collecting portion (3); the sleeve portion (1), defining a hollow sleeve configured to retain a fixing part (201) and a rotating part (203) of the electrical drill (200), one end of which is coupled with the fixing part (201) of the electrical drill (200) and the other end is connected with the supporting portion (2); the sleeve portion (1) surrounding, isolating, and keeping clear of the rotating part (203) disposed in a front section of the fixing part (201); the supporting portion (2), defining an annular ring having a through hole disposed in a center thereof provided for a drill bit (202) inserted therethrough, one end of which is coupled with sleeve port (1) and the other end connected with the dust collecting portion (3); the dust collecting portion (3), including a telescoping sleeve body (31) coupled to the supporting portion (2) and a spring (32) disposed inside the telescoping sleeve body (31); the telescoping sleeve body (31) sequentially comprising a ring body (311), a dust collection section (312), a bellows section (313), a connecting ring (314); the ring body (311) having an opening (3111) provided for the drill bit (202) passing therethrough; the dust collection section (312) connected to the corresponding end of the ring body (311), the bellows section (313) connected to the other corresponding end of the dust collection section (312), the connecting ring (314) connected to the other corresponding end of the bellows section (313), and the other end of the connecting ring (314) connected to an outer periphery of the supporting portion (2); the spring (32), defining a compression spring and disposed around the outside periphery of the drill bit (202), one end of which is coupled with an inner wall of the ring body (311) and the other end is positioned in a corresponding position of the supporting portion (2).

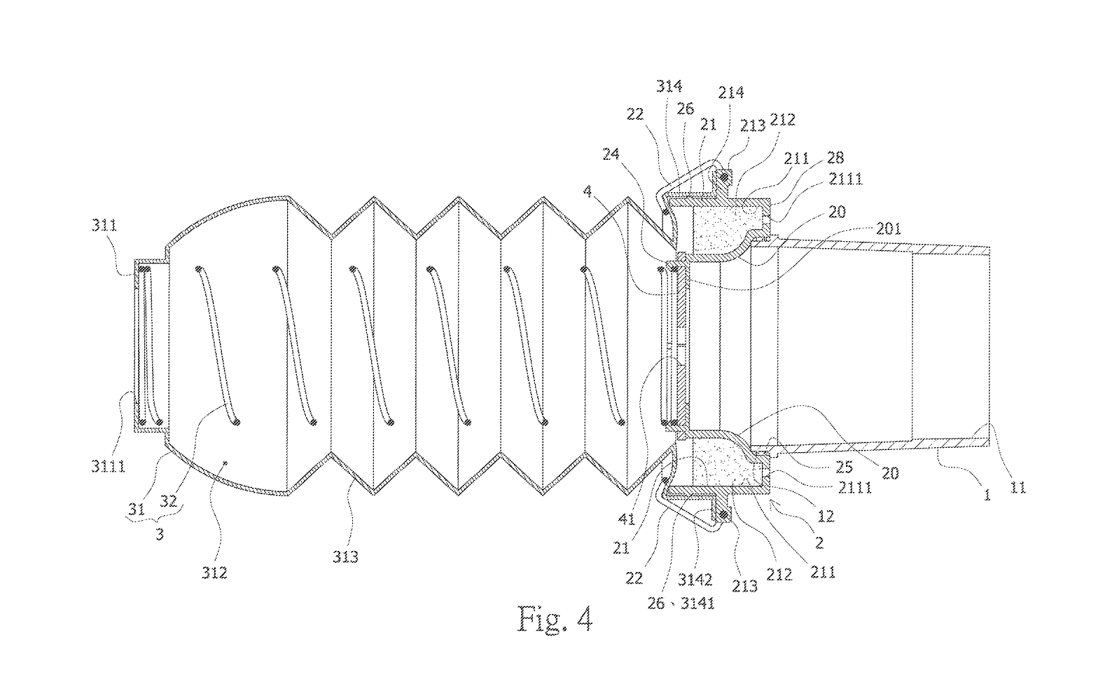

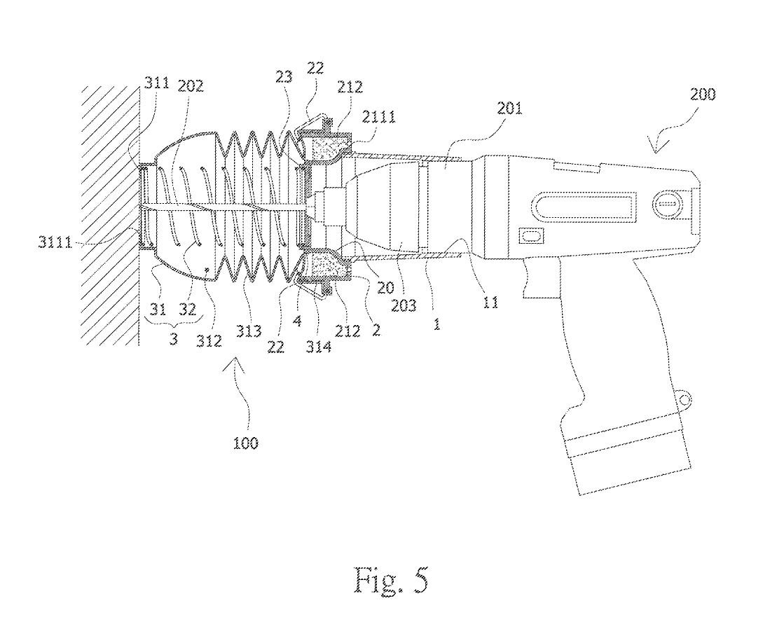

FIG. 4 and FIG. 5 are respectively a cross-sectional and a using state view of the first embodiment, wherein the sleeve portion (1) sleeved and fixed with the fixing part (201) of the electrical drill (200) without deviation therebetween, and keeping clear of the rotating part (203); the supporting portion (2) is a fixing and middle body connecting between the sleeve portion (1) and the dust collecting portion (3); due to unrotatable structure, a user can directly hold the supporting porting (2) to drill safely; the dust collecting portion (3) is to collect the dust and not affect to the normal motion of the hands while drilling.

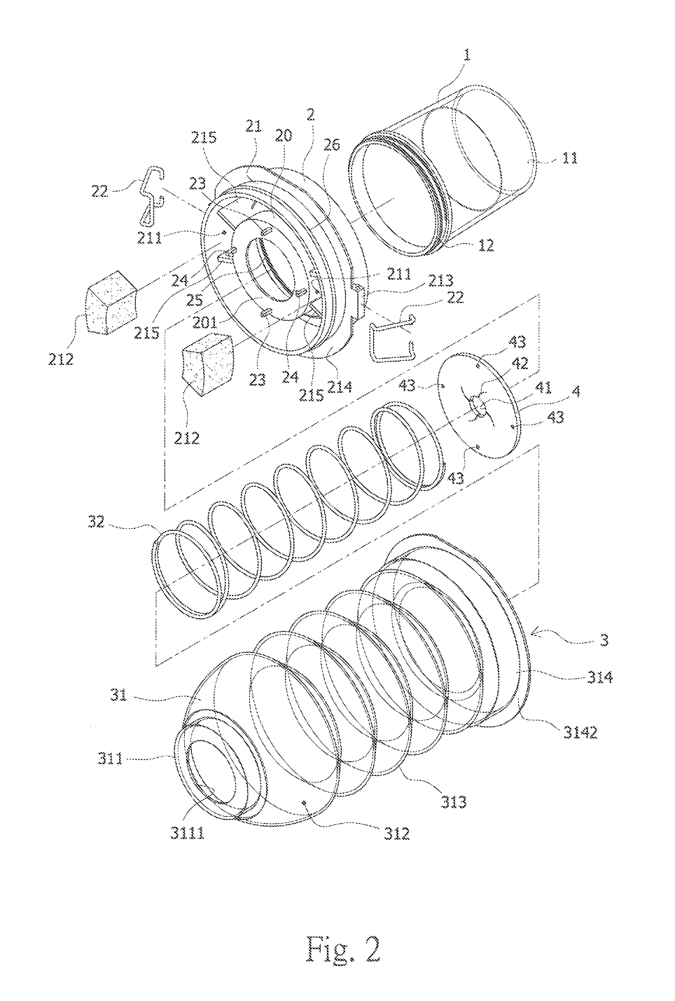

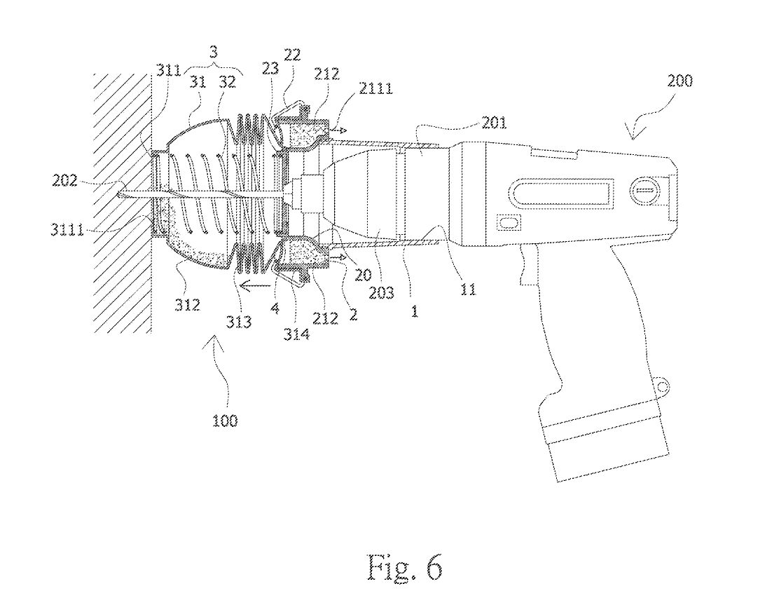

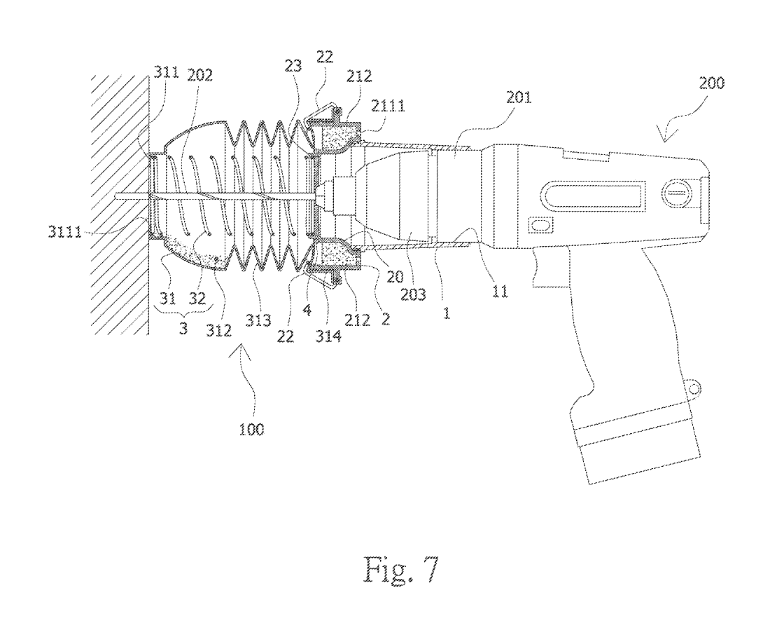

FIG. 5 discloses the ring body (311) of the dust collecting portion (3) can fit tightly with a wall by the spring (32) to decrease dust leaking out of the dust collecting portion (3) and increase dustproof effect. FIG. 6 discloses the dust collection section (312) can collect the dust in the area and the bellows section (313) is an extensible structure which can be compressed to push the polluted air out from the dust collecting portion (3) through the filter net (212) and the air outlets (2111) avoid contamination when a drilling equipment is to drill a hole, besides, which can back automatically to its normal shape when the drilling equipment is to be pulled out from the hole; the connecting ring (314) is to connect tie dust collecting portion (3) and the supporting portion (2), and to provide better sealing effect to avoid dust leaking,

wherein the supporting portion (2) as shown in FIG. 2 and FIG. 4 comprises an inner ring body (20) axially corresponding and connected to the sleeve portion (1), an outer ring body (21) axially corresponding and connected to the inner ring body (20), and the diameter of which being larger than the inner ring body (20); one end of the inner and outer ring body being integrally connected by a vertical block ring (28), which forms a dust collection chamber (211) arranged therebetween; the dust collection chamber (211) having a filter net (212) and the block ring (28) having a plurality of air outlets (2111) corresponding to the filter net (212); wherein the filter net (212) of the dust collection chamber (211) has two partition plates (215) arranged at both sides for fixing thereof.

wherein the connecting ring (314) of the dust collecting portion (3) as shown in FIG. 2 to FIG. 4 is connected to an outer periphery of the outer ring body (21) and has a convex ring (3142) disposed around an outer edge thereof; the outer ring body (21) including a stop ring (214) arranged around the outer periphery thereof to block the convex ring (3142) for a better sealing effect, at least two lugs (213) arranged in corresponding positions, and at least two fasteners (22) with hooks arranged at both sides of the lugs (213) and fastened to a top edge of the connecting ring (314) and the outer ring body (21); therefore, when the dust collecting portion (3) combined with the supporting portion (2), the fasteners (22) can be easily and quickly fixed to or removed from the dust collecting portion (3) by turning the fasteners itself inwardly or outwardly.

wherein the inner ring body (20) includes a bottom ring (201) disposed in one end thereof, at least two positioning blocks (23) correspondingly arranged in an outer face thereof, and at least two inverted L-shape protruding blocks (24) correspondingly disposed and staggered with the positioning blocks (23) for fixing the spring (32) in the outer face of the bottom ring (201).

wherein the bottom ring (201) further includes a flexible block plate (4) to block the through hole, a perforation (41) disposed in a center circle of the block plate to allow the drill bit (202) passing therethrough, a plurality of slits (42) evenly arranged around the perforation (41), and a plurality of locating holes (43) configured to fix the positioning blocks (23) and the protruding blocks (24). The block plate can prevent the dust from entering into the supporting portion and make the drill bit operation smoothly. On the other hands, the perforation (41) and the slits can receive larger drill bit and the rotating part (203) to ensure the smoother operation; the locating holes (43) makes the flexible block plate (4) more stable and avoids deflection with the spring (32).

The sleeve portion (1), supporting portion (2), and dust collecting portion (3) are transparent plastics so that the user can directly check the drilling status and avoid dangerous.

wherein the sleeve portion (1) as shown in FIG. 4 comprises an thickened inner wall (11) corresponding to the fixing part (201) of the electrical drill (200) for receiving the fixing part (201) and an outer thread (12) arranged in an outer periphery of one end thereof for screwing to the supporting portion (2) which has an inner thread (25) corresponding to the outer thread (12). The thickened inner wall (11) prevents the sleeve portion (1) from falling off the fixing part (201). Besides, the outer thread (12) and the inner thread (25) makes the sleeve portion (1) quickly connect with and remove from the supporting portion to achieve assembled stably and dissembled easily.

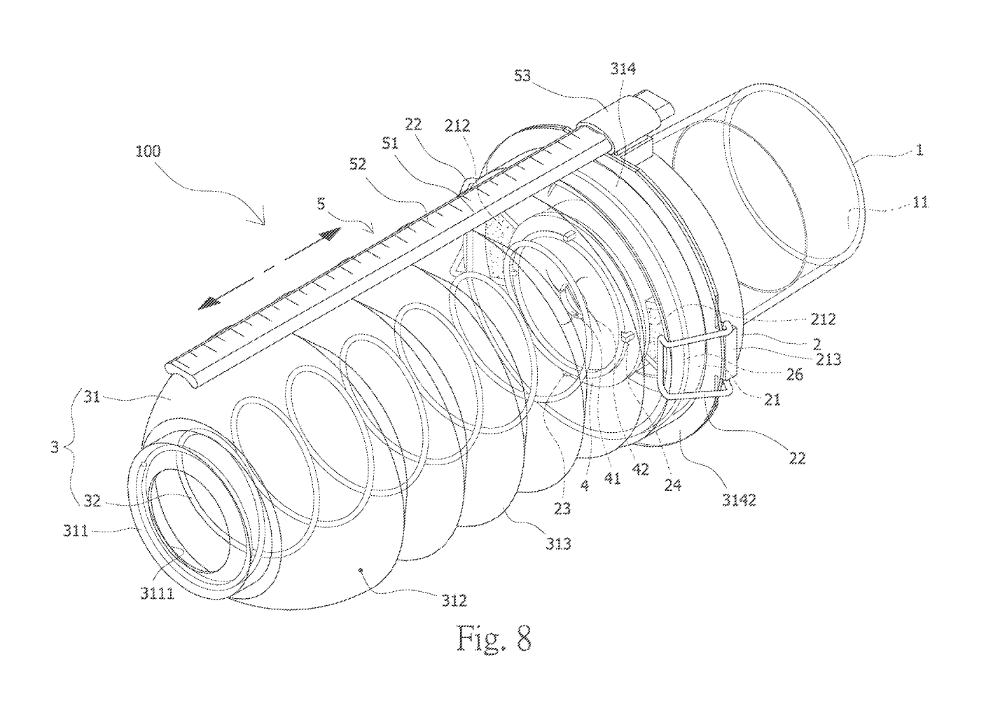

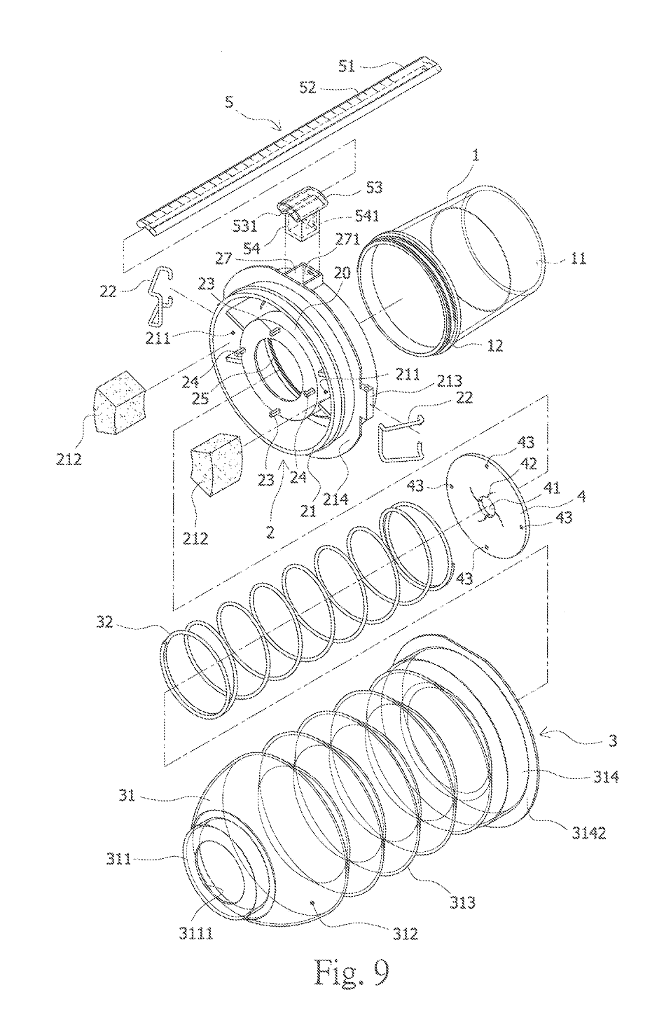

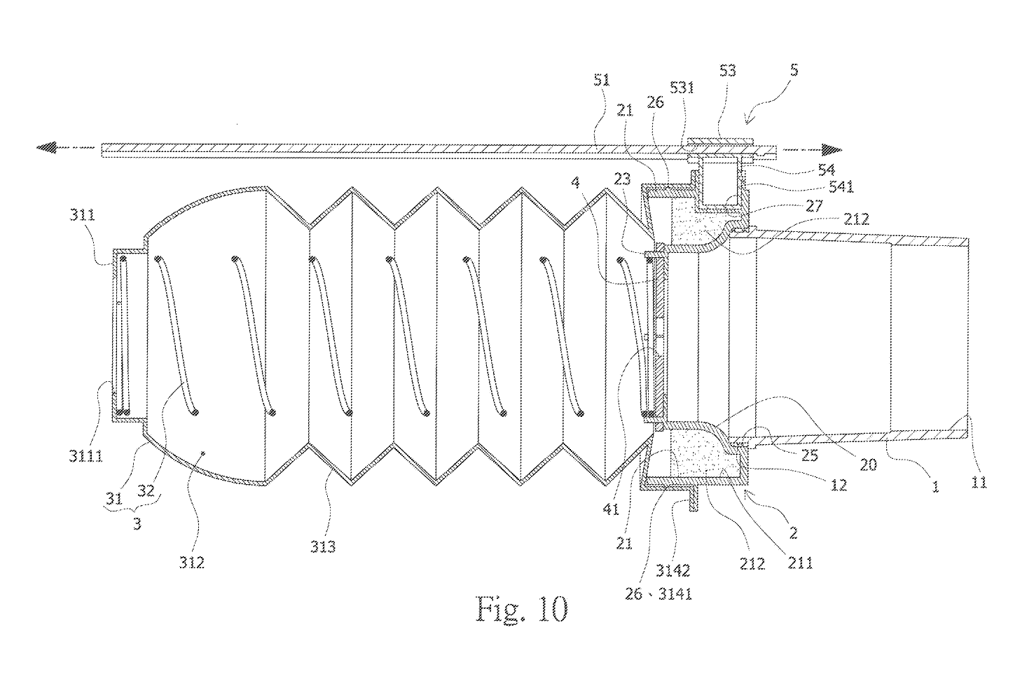

FIG. 8 to FIG. 10 are the second embodiment of the present invention which disclose the dust collector (100) further comprising a stop device (5) which comprises an ruler (51) with scale (52) paralleled to the dust collecting portion (3) and being adjustable in length, a stopper (53) disposed at the outer edge of the supporting portion, a fixing hole (531) arranged in one end of the stopper (53) and configured to move and fix the ruler (51), and a locating pillar (54) disposed in the other end of the stopper (53) and coupled to the supporting portion (2); the supporting portion (2) having a locating recess (27) disposed in the outer edge thereof provided for the locating pillar inserted therein.

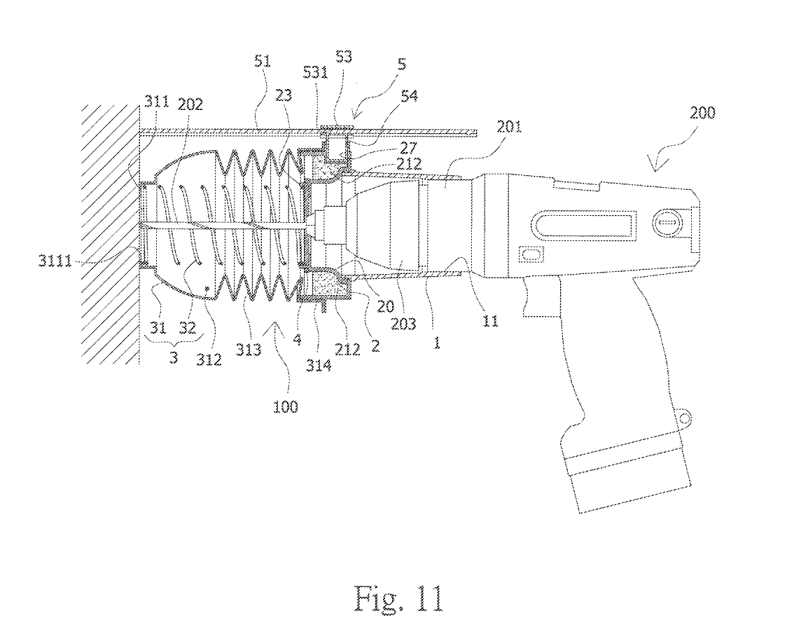

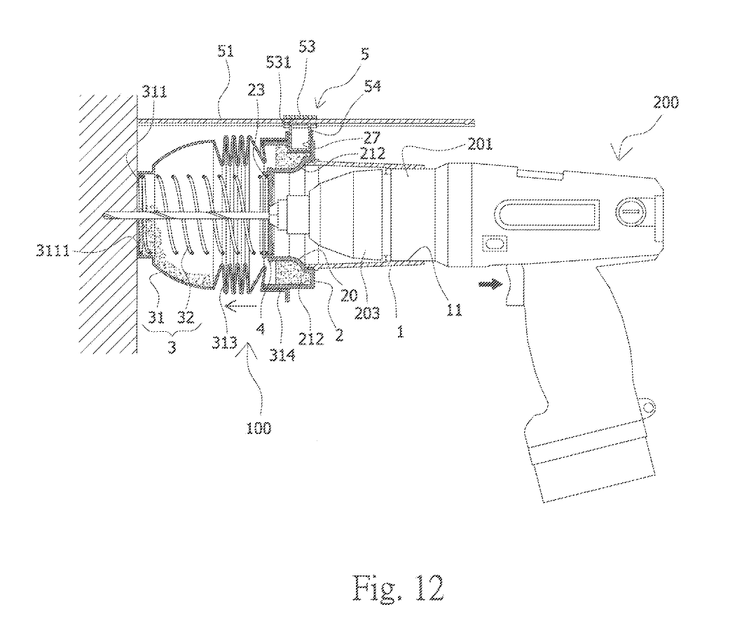

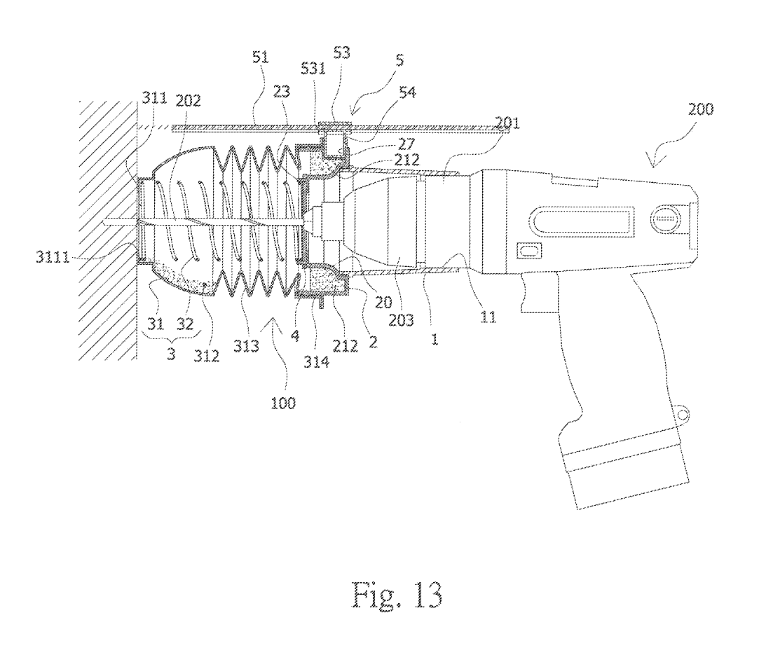

Referring to FIG. 11 to FIG. 13, the second embodiment adds the stop device (5), the ruler (51) of which adjusts to zero on the scale (52) before drilling, and then one side of the ruler (51) presses against the wall to drill for a predetermined depth, by which the users can easily check the scale (52) of the ruler (51) to precisely control the drilling depth.

Besides, the stopper (53) has clip function which is configured to avoid the ruler (51) falling off and locate the scale (52) easily; the locating pillar (54) and the locating recess (27) are configured to provide the stop device (5) installed and removed quickly.

Wherein the locating recess (27) has a positioning hole (271) disposed in one side wall thereof, and the locating pillar (54) has a spring block (541) disposed in one side wall thereof for inserting into the positioning hole (271).

The spring block (541) and the positioning hole (271) are configured to avoid the stop device (5) falling off.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A dust collector (100) for electrics drill (200), comprising:
sleeve portion (1),
supporting portion (2), and
a dust collecting portion (3);
the sleeve portion (1), defining a hollow sleeve configured to retain a fixing part (201) and a rotating part (203) of the electrical drill (200), one end of which is coupled with the fixing part (201) of the electrical drill (200) and the other end is connected with the supporting portion (2); the sleeve portion (1) surrounding, isolating, and keeping clear of the rotating part (203) disposed in a front section of the fixing part (201);
the supporting portion (2), defining an annular ring having a through hole disposed in a center thereof provided for a drill bit (202) inserted therethrough, one end of which is coupled with sleeve port (1) and the other end connected with the dust collecting portion (3);
the dust collecting portion (3), including a telescoping sleeve body (31) coupled to the supporting portion (2) and a spring (32) disposed inside the telescoping sleeve body (31); the telescoping sleeve body (31) sequentially comprising a ring body (311), a dust collection section (312), a bellows section (313), a connecting ring (314); the ring body (311) having an opening (3111) provided for the drill bit (202) passing therethrough; the dust collection section (312) connected to the corresponding end of the ring body (311), the bellows section (313) connected to the other corresponding end of the dust collection section (312), the connecting ring (314) connected to the other corresponding end of the bellows section (313), and the other end of the connecting ring (314) connected to an outer periphery of the supporting portion (2); the spring (32), defining a compression spring and disposed around the outside periphery of the drill bit (202), one end of which is coupled with an inner wall of the ring body (311) and the other end is positioned in a corresponding position of the supporting portion (2).

2. The dust collector for electrical drill as claimed in claim 1, wherein the supporting portion (2) comprises an inner ring body (20) axially corresponding and connected to the sleeve portion (1), an outer ring body (21) axially corresponding and connected to the inner ring body (20), and the diameter of which being larger than the inner ring body (20); one end of the inner and outer ring body being integrally connected by a vertical block ring (28), which forms a dust collection chamber (211) arranged therebetween; the dust collection chamber (211) having a filter net (212) and the block ring (28) having a a plurality of air outlets (2111) corresponding to the filter net (212); wherein the filter net (212) of the dust collection chamber (211) has two partition plates (215) arranged at both sides for fixing the filter net (212).

3. The dust collector for electrical drill as claimed in claim 2, wherein the inner ring body (20) includes a bottom ring (201) disposed in one end thereof, at least two positioning blocks (23) correspondingly arranged in an outer face thereof, and at least two inverted L-shaped protruding blocks (24) correspondingly disposed and staggered with the positioning blocks (23) for fixing the spring (32) in the outer face of the bottom ring

4. The dust collector for electrical drill as claimed in claim 4, wherein the bottom ring (201) further includes flexible block plate (4) to block the through hole, a perforation (41) disposed in a center circle of the block plate to allow the drill bit (202) passing therethrough, a plurality of slits (42) evenly arranged around the perforation (41), and a plurality of locating holes (43) configured to fix the positioning blocks (23) and the protruding blocks (24).

5. The dust collector for electrical drill as claimed in claim 1, wherein the connecting ring (314) of the dust collecting portion (3) is connected to an outer periphery of the outer ring body (21) and has a convex ring (3142) disposed around an outer edge thereof; the outer ring body (21) including a stop ring (214) arranged around the outer periphery thereof to block the convex ring (3142) for a better sealing effect, at least two lugs (213) arranged in corresponding positions, and at least two fasteners (22) with hooks arranged at both sides of lugs (213) and fastened to a top edge of the connecting ring (314) and the outer ring body (21).

6. The dust collector for electrical drill as claimed in claim 1, wherein the sleeve portion (1) comprises a thickened inner wall (11) corresponding to the fixing part (201) of the electrical drill (200) for receiving the fixing part (201) and an outer thread (12) arranged in an outer periphery of one end thereof for screwing to the supporting portion (2) which has an inner thread (25) corresponding to the outer thread (12).

7. The dust collector for electrical drill as claimed in claim 1, wherein the supporting portion (2) includes an annular convex strip (26) disposed in an outer face between the supporting portion (2) and the connecting ring (314), and an annular concave groove (3141) arranged in an inner wall of the connecting ring (314) and corresponding to the convex strip (26).

8. A dust collector for electrical drill as claimed in claim 1, further comprising
a stop device (5) which comprises an ruler (51) with scales (52) paralleled to the dust collecting portion (3) and being adjustable in length, a stopper (53) disposed at the outer edge of the supporting portion, a fixing hole (53) arranged in one end of the stopper (53) and configured to move and fix the ruler (51), and a locating pillar (54) disposed in the other end of the stopper (53) and coupled to the supporting portion (2); the supporting portion (2) having a locating recess (27) disposed in the outer edge thereof provided for the locating pillar inserted therein.

9. The dust collector for electrical drill as claimed in claim 9, wherein the locating recess (27) has a positioning hole (271) disposed in one side wall thereof, and the locating pillar (54) has a spring block (541) disposed in one side wall thereof for inserting into the positioning hole (271).
